(19) United States
(12) Patent Application Publication
(10) Pub. No.: US 2007/0249825 A1
(43) Pub. Date: Oct. 25, 2007

(54) Decolorized raw cotton linters and preparation of ether derivatives therefrom

(76) Inventor: Arjun C. Sau, Newark, DE (US)

Correspondence Address: Hercules Incorporated;Hercules Plaza, 1313 N. Market Street, Wilmington, DE, 19894-0001, US

(21) Appl. No.: 11/788,057

(22) Filed: Apr. 19, 2007

Related U.S. Application Data
(60) Provisional application No. 60/793,798, filed on Apr. 21, 2006.

(51) Int. Cl. C08B 11/20

(52) U.S. Cl. 536/86

(57) ABSTRACT

A process for decolorizing cut raw cotton linters (RCL) through the removal of color bodies contained in the cut RCL mass is disclosed as well as a process for using the resultant decolorized RCL in the production of cellulose ether derivatives.

### RELATED APPLICATIONS

This application claims the benefit of U.S. Provisional Application Ser. No. 60/793,798, filed on Apr. 21, 2006, which is incorporated herein by reference in its entirety.

### FIELD OF INVENTION

The present invention is related to decolorized cut raw cotton linters, a method of preparing decolorized cut raw cotton linters, and a method of preparing ether derivatives from decolorized cut raw cotton linters.

### BACKGROUND OF THE INVENTION

Currently, purified cotton linters are used to manufacture various types of high molecular weight cellulose ethers (CEs). These CEs are used in aqueous systems, such as water-borne coatings, drilling muds, dry-mortar construction materials, tile adhesives, joint compounds, etc. to deliver the desired rheological properties. In these applications, a slight color of the CE is not an issue so long as the desired Theological performance is delivered. Typically, the color of commercial CEs varies between light brown and white.

Raw cotton linters (RCL) are dark brown due to the presence of colored impurities, such as lignin. Currently, purified cotton linters are manufactured by removing non-cellulosic and colored impurities from RCL. Removal of colored impurities from RCL is critical to enhance the whiteness of the cellulose fibers. The current method of removing impurities from RCL involves multi-step treatment of RCL involving mechanical separation, thermal and chemical treatment, and bleaching with oxidizing agents. Because of these multiple treatments, cellulose tends to lose its molecular weight during the purification of RCL. Consequently, CEs made from purified cotton linters do not exhibit very high solution viscosity. Obviously, there is a need to develop alternative technologies to decolorize and/or purify RCL to the desired level without occasioning molecular weight loss of cellulose.

### SUMMARY OF THE INVENTION

The present invention is directed to a process for making a decolorized RCL wherein the colored impurities present in RCL are substantially removed by cutting RCL to short fiber lengths and heating the cut RCL with caustic solutions at elevated temperatures at or above ambient pressure for a sufficient time to extract the color bodies from RCL. The whiteness of the caustic-extracted RCL can be enhanced by optionally bleaching the caustic-extracted RCL with appropriate reagents.

The process for removing colored bodies from RCL comprises the steps of a) cutting the raw cotton linters so that at least 50% of the mass passes through a US Standard sieve size #10 (2 mm opening), b) mixing cut RCL with from 2% to 10% of a base solution, c) heating the mixture at a temperature of from about 90° C. to about 180° C. for a sufficient time to remove the color bodies from the RCL to produce a decolorized RCL, d) an optional step to remove the base solution, e) washing the decolorized RCL with water to remove residual base solution and color bodies from the decolorized RCL, f) an optional step wherein the decolorized RCL is treated with an oxidizing agent, g) an optional step wherein the decolorized RCL is neutralized and washed and h) the decolorized RCL is dried.

The present invention also comprehends a process for preparing ether derivatives from such decolorized RCL by treating the decolorized RCL with a base and then reacting the base-treated decolorized RCL with an etherifying agent. The ether derivatives made from decolorized RCL are substantially lighter in color than analogous derivatives made from “as is” RCL.

The process of the present invention offers a number of additional benefits for manufacturers of both purified linters and cellulose ethers relative to current manufacturing practices. Cellulose ether manufactures have long known that cut cellulose furnishes provide a number of benefits in their process. These materials enable a more uniform alkali cellulose and resulting derivatives to be prepared than what is possible using uncut cellulose. Cutting results in a higher bulk density fiber which permits increased reactor loading thereby increasing plant capacity. In current cellulose ether manufacturing processes the cutting operation is performed after RCL purification. It is common practice that each cellulose ether plant has a series of expensive cutters dedicated to this function. The use of previously cut cellulose by CE manufacturers greatly simplifies materials handling and reduces capital investment at the CE plant.

By cutting RCL at the beginning of their process, producers of purified cotton linters also gain a number of benefits. Uncut RCL is a heterogeneous mass of entangled fibers interspersed with larger seed hulls and other plant fragments as well as inorganic matter. In addition to using traditional mechanical separation techniques prior to chemical treatment, other mechanical separation approaches such as those disclosed in U.S. patent Ser. No. 11/179,301 (US Patent Application No 2006/0010669A1), the disclosure of which is incorporated herein by reference in its entirety, may be utilized to remove bulk contaminants. The short fibers present in the cut material are more readily mixed with extraction reagents thereby expediting the extraction process. In addition, by reducing the size of seed hulls and other plant fragments the impurities are more readily extracted. This permits the use of milder extraction conditions which result in chemical and energy savings, decreased cycle time, as well as increased preservation of molecular weight. The higher bulk density of the cut material also permits greater reactor loading during the chemical extraction steps associated with the purification process thereby increasing plant capacity.

### DETAILED DESCRIPTION OF THE INVENTION

It has been surprisingly found that the colored bodies present in second-cut RCL can be substantially removed simply by cooking cut RCL in ≧3% base solution at ≧90° C. for a sufficient time and washing decolorized RCL with water.

Prior to chemical extraction, mechanical separation processes such as those disclosed in U.S. patent Ser. No. 11/179,301 may be utilized to remove bulk contaminants. These treatments may be performed on either uncut or cut RCL.

Prior to chemical extraction, it is necessary to cut the RCL mass. The RCL should be cut to a level so that at least 50% of the cut RCL mass passes through a US Standard sieve size #10 (2 mm opening). Preferably, the RCL should be cut to a level so that at least 50% of the mass in the cut RCL mass passes through a US standard sieve size #18 (1 mm opening), more preferably wherein at least 50% of the mass in the cut RCL mass passes through a US standard sieve #35 (0.5 mm opening), still more preferably wherein at least 50% of the mass in the cut RCL mass passes through a US standard sieve #60 (0.25 mm opening).

A wide range of equipment can be used to comminute or cut the RCL to the desired ranges, including, but not limited to, rotary cutters, hammer mills, ball mills, jet mills, and/or vibration mills. It is preferred that the cutter produces substantially no heat buildup during the cutting of cellulose. In some cases, it may be desirable to use an inert atmosphere, substantially oxygen-free atmosphere, in order to minimize or prevent degradation of cellulose. One method of obtaining an inert atmosphere, substantially oxygen-free atmosphere, is to use nitrogen. A preferred means involves the use of a Netzsch Condux® Cutting Granulator CS. Such cutting will lead to an increase in the bulk density of the material relative to that observed for a previously debated uncut sample. To further prevent molecular weight loss, cryogenic grinding may be utilized to both reduce temperature and maintain an inert atmosphere in the cutting chamber.

It is preferred that the cut RCL content used in the decolorization process is from about 1% to about 50% solids. Decolorization of cut RCL can be carried out in a slurry process or, alternatively, in a high solids process. Examples of high solids reactors include batch digesters, continuous digesters such as a Pandia® digester offered by Lenzing AG, as well as twin-screw extruders such as those available from Clextral Group. Base-digestion of the cut RCL can be carried out at ambient pressure at a temperature from about 90° C. to about 100° C. or at elevated temperatures of greater than about 100° C. Base-digestion of the cut RCL can be also carried out at elevated pressures. The base digestion may be accomplished using base materials commonly used in the cellulosic arts and may be selected from the group consisting of sodium hydroxide, potassium hydroxide, lithium hydroxide, and mixtures thereof. Surfactants may be added to the base-digestion step. The surfactant of use in the present invention may be selected from the group consisting of the surfactant is selected from the group of sulfonated castor oil, Turkey Red oil, FF wood rosin, crude tall oils, and mixtures thereof.

Following base-digestion, decolorized RCL fibers should be separated from the color-containing black liquor. Generally, this step includes multiple water washing and fiber:liquor separation cycles. To conserve water the sequential steps can be performed in a counter-current manner wherein a portion or all of the water from a downstream washing step is re-used in an upstream washing step. The black liquor can be separated from the decolorized RCL fibers using a mechanical treatment designed to remove the excess fluid. The mechanical treatments used for removing excess fluid may be selected from the group consisting of gravity filtration, belt presses, centrifuges, and twin screw extruders which are equipped with appropriate screw and barrel designs. One advantage of using a twin screw extruder in the present process is that the extruder may be equipped with multiple washing sections to effectively remove substantially all of the excess fluid from the decolorized RCL fibers. Additionally, effluent from each extruder washing section may be fed in a countercurrent manner in order to minimize the amount of wash water needed. It is desirable that after the washing step is performed by any of the above-mentioned treatments, that the washed decolorized RCL be substantially free of caustic.

To enhance whiteness, the decolorized RCL can be further treated with bleaching agent(s) or oxidizing agents under appropriate conditions. Examples of suitable oxidizing agents may be selected from the group consisting of hydrogen peroxide, sodium hypochlorite, chlorine dioxide, chlorine, oxygen and ozone. If needed, the molecular weight of the cellulose can be lowered by treating the decolorized RCL with a suitable cellulose degrading agents.

The decolorized RCL is neutralized, washed, and dried. Suitable dryers for drying the decolorized RCL are selected from the group consisting of tunnel belt dryers, impact dryers, tower dryers, and multistage flash dryers. The dried, cut, purified, decolorized RCL may then be used for etherification.

The decolorized RCL produced by the process of the present invention exhibits a Hunter L whiteness of at least about 60, preferably at least about 70, more preferably at least about 80, still more preferably at least about 95.

The decolorized RCL of the present invention can be used to make a wide range of cellulose ether derivatives. Examples of cellulose ether derivatives include carboxymethylcellulose (CMC), methylcellulose (MC), ethyl cellulose (EC), hydroxyethylcellulose (HEC), carboxymethylhydroxyethylcellulose (CMHEC), hydrophobically-modified hydroxyethylcellulose (HMHEC), hydrophobically modified carboxymethyl hydroxyethylcellulose (HMCMHEC), methylhydroxyethylcellulose (MHEC), methylhydroxypropylcellulose (MHPC), ethylhydroxyethylcellulose (EHEC), hydrophobically-modified ethylhydroxyethylcellulose (HMEHEC), hydroxypropylcellulose (HPC), hydrophobically-modified hydroxypropylcellulose (HMHPC), allylated hydroxyethylcellulose, and sulfonated hydroxyethylcellulose. Other ether derivatives could bear tertiary amino groups or cationic substituents. The cationic substituents or reagents may be glycidyltrimethylammonium chloride. The cationic substituents or reagents may comprise a hydrophobic group. The hydrophobic group may be an alkyl group containing from 2 to 20 carbon atoms.

In preparing a cellulose ether derivative using the decolorized RCL, the RCL is treated with a base. The base-treated decolorized RCL is reacted with an etherifying agent or a mixture of etherifying agents at a sufficient temperature and for a sufficient time to form the cellulose ether. An advantage of using the decolorized RCL rather than “as is” RCL is that the final cellulose ether derivative made from decolorized RCL is substantially lighter in color than the analogous CE made from “as is” RCL.

If desired, the ether derivative product made using the decolorized RCL may be further processed to increase its purity. Typically, the ether derivative product made using the decolorized RCL is further processed to increase its purity by extracting nonpolymeric salts from the final product through the use of liquid media in which the ether derivative is rendered substantially insoluble.

The final ether derivative product made using the decolorized RCL by the process of the present invention may yield high amounts of cellulose ether derivative compared to the yield of cellulose ether made from “as is” RCL. Preferably the final ether derivative product produced in the process of the present invention yields at least 65% of the cellulose ether derivative by weight, more preferably the final ether derivative product contains at least 75% of the cellulose ether derivative by weight, still more preferably the final ether derivative product contains at least 95% of the cellulose ether derivative by weight.

To produce the cellulose ether derivative using decolorized RCL, the decolorized RCL may be first treated with the etherifying agent and then treated with a base to form the cellulose ether derivative. Alternatively, the decolorized RCL may be treated simultaneously with an etherifying agent and a base to form the cellulose ether derivative.

The bases used in the preparation of the cellulose ether derivative are those that are known in the art and may be selected from the group consisting of sodium hydroxide, potassium hydroxide, calcium hydroxide, barium hydroxide, ammonium hydroxide, lithium hydroxide, strong organic bases and mixtures thereof. The strong organic bases for use in the preparation of the cellulose ether derivative may be selected from the group consisting of amines, quaternary ammonium hydroxides, and mixtures thereof. A preferred base for use in the preparation of cellulose ether derivatives is sodium hydroxide.

The etherifying agent used in the preparation of the cellulose ether derivative are those that are known in the art and may be selected from the group consisting of alkyl halides, alkenyl halides, alkylene oxides, alkyl glycidyl ethers, aryl glycidyl ethers, alk(aryl) glycidyl ethers, metal salts of alpha-halogenoalkanoates, vinyl sulfonates, and mixtures thereof. It is also possible to select the etherifying agent from the group consisting of methyl chloride, ethyl chloride, ethylene oxide, propylene oxide, monochloroacetic acid and salts thereof, butyl glycidyl ether, and glycidyl silane. In particular, the etherifying agent may be 3-glycidoxypropyl)trimethoxysilane. (3-glycidoxypropyl)methyldiethoxysilane or (3-glycidoxypropyl)dimethoxysilane.

The carboxymethylated derivatives made from decolorized RCL are water-soluble or water-swellable and exhibit enhanced solution viscosity. They provide improved performance properties (higher saturated salt water and fresh water Fann viscosity) in water-based drilling muds as compared to carboxymethylated RCL (CM-RCL) made from “as is” RCL.

Similarly, the hydroxyethylated derivatives made by reacting the decolorized RCL with ethylene oxide exhibit solution viscosity higher than analogous derivatives made from commercially available high molecular weight purified cotton linters, obtained by exhaustive purification of RCL.

Alternatively, if lower intrinsic viscosity of the resultant cellulose ether is desired, the starting decolorized RCL or the cellulose ether derivative may be further processed with a viscosity reducing agent to lower the intrinsic viscosity of the cellulose ether. Typical viscosity reducing agents for lowering the intrinsic viscosity of the cellulose ethers include chemical means, mechanical means, irradiation, and enzymatic means.

The decolorized RCL produced by the process of the present invention may contain a small amount of lignin and hemicellulose and these entities could undergo etherification during the etherification of the decolorized RCL.

The decolorized RCLs of the present invention could be used as lower cost alternatives to commercially available purified cotton linters to manufacture assorted cellulose ethers for industrial applications.

### Standard Procedures

1. Cellulose Molecular Weight Determination by Size Exclusion Chromatography

Cellulose samples were converted to the methylol cellulose derivative according to the method described by D C Johnson, et.al. in Applied Polymer Symposium, No. 28, 931-943 (1976) with the following changes:
1. Cellulose concentration in solution was 0.14%
2. Solvent used was dimethyl sulfoxide containing 1% lithium chloride

Molecular weight was determined by the gel permeation method described by J L Wood in Journal of Liquid chromatography, 2, 309-318 (1979) with the following changes:
1. A PL-Gel Linear A column from Polymer labs was used
2. The column and detector temperatures were set at 45° C.
3. The mobile phase was dimethyl sulfoxide containing 1% lithium chloride and 3% formalin
4. Narrow molecular weight pullulans were used as calibration standards.
   2. Hunter L Whiteness Measurement

Sample disks were prepared by compression molding 2.5 g of material 40 mm circular die at a pressure of 10,000 lbs. The die is a model 3614 die available from Spex Industries and is normally used to prepare samples for x-ray fluorescence measurements. To facilitate sample handing, the loose fiber was compression molded using compressible tapered PlastiCups® (catalog number 5541, Spec Industries). A Carver 25 ton hydraulic two column press (Model 3853) was used to apply pressure to the die.

For each sample, five Hunter optical whiteness readings (center, top, bottom, left, and right) on the disk's surface were measured and averaged using an X-Rite 532 Spectrodensitometer. (L*a*b* observer angle=2°)

3. Relative Solution Color

Relative solution colors were obtained using the following procedure: Visible absorbance spectra of 1% solutions of the water soluble polymer of interest were measured with a Shimatzu UV-1201 UV/Visible spectrophotometer using plastic 1 cm cuvettes at resolution of 0.5 nm relative to a de-ionized water reference. The resulting spectra were then weighted by a function which reflected the sensitivity of the human eye to color (Standard Observer under daylight lighting conditions) as reported by the Commission Internationale d'Eclairage (CIE). The peak intensity in the weighting function was normalized to 100. After weighting, the values in the resulting spectra were then averaged over the range of 400 to 700 nm. The average values were reported as the Relative Solution Color. A value of zero represents a perfectly transparent solution. Higher values are indicative of solutions which the human eye would perceive of being darker in color.

4. Sulfuric Acid Insolubles Measurements

This method determined the insoluble fraction remaining after the cellulosic sample was treated twice with concentrated sulfuric acid. A weighed sample of the cellulose furnish was treated with 72% (w/w) sulfuric acid for four hours at room temperature. Then the mixture was diluted to 1.2 M acid strength and heated under reflux for four hours. The residue was washed free of acid, dried and weighed.

If hexane solubles are to be performed on the same sample, the dried material remaining after that analysis should be used for determination of sulfuric acid insolubles, to prevent overestimation of total impurities.

Apparatus

1. Beaker, 50 mL, borosilicate.

2. Graduated cylinders, 25 and 250 mL.

3. Stirring bar, Teflon coated, one inch.

4. Magnetic stirrer.

5. Erlenmeyer flask, 500 mL, with 29/26 or 29/42 ground glass joint—available from Ace Glass, Inc, 1430 North West Blvd, Vineland, N.J. 08362-0688, Cat. No. 6965-38, or equivalent.

6. Allihn condenser with 29/42 ground glass joint, ibid., Cat No. 5945-24, or equivalent.

7. Boiling chips, alumina granules—available from Fisher Scientific, Inc., Cat. No. B365-250, or equivalent.

8. Hot plate, with adjustable power settings. A multi-heater unit may be used for several simultaneous determinations.

9. Filtering crucible, Gooch, porcelain, 25 mL—available from Fisher Scientific, Inc., Cat. No. 08-195E (Coors), or equivalent.

10. Crucible holder, Walter type—ibid., Cat. No. 08-285, or equivalent.

11. Filtering flask, 1000 mL. Attach to a source of vacuum with suitable rubber tubing.

12. Filter paper, glass fiber, 2.1 cm diameter—available from Fisher Scientific, Inc., Cat. No. 09-874-10 (Whatman type GF/A), or equivalent.

13. Oven, drying, capable of operating at 105° C.

14. Balance, capable of weighing to the nearest 0.0001 g.

15. Desiccator. Charge with calcium sulfate desiccant, Reagent 3.

Reagents

1. Sulfuric acid, reagent grade.

2. Sulfuric acid, 72% solution -635 mL of sulfuric acid, and Reagent 1, were carefully added with cooling to 365 mL of distilled or deionized water. The solution was cooled to room temperature before using.

3. Calcium sulfate desiccant (Drierite)—use any suitable grade.

Procedure

1. A 1 to 1.1 g portion of sample was weighed, to the nearest 0.0001 g, into a 50 mL beaker.

2. 20 mL of 72% sulfuric acid, Reagent 2, were added with a graduated cylinder to the beaker

3. A stirring bar was added to the beaker and the mixture was stirred for 4 hours with a magnetic stirrer at room temperature with sufficient stirring to wet the sample. During the first part of the stirring, the sample was thoroughly wetted with reagent. When necessary, a stirring rod was used to push the sample into the reagent, taking care not to lose any of the sample.

4. The solution was cautiously transferred into a 500 mL flask by washing with a total of 180 mL of distilled water.

5. The flask was attached to a reflux condenser and the mixture was heated under reflux on the hot plate for 4 hours.

6. While the sample was refluxing, a glass fiber filter paper was placed in a Gooch crucible, wetted with distilled water, and vacuum was applied to remove the water and set the filter in place.

7. The crucible and filter were dried for one hour in a 105° C. oven.

8. The crucible and filter were weighed to the nearest 0.0001 g.

9. The reflux mixture was cooled and the solution was filtered through the crucible under vacuum.

10. The flask was rinsed with four 10 mL portions of distilled water and then added to the filter, ensuring all insoluble material was transferred.

11. The crucible was rinsed with 10 mL of water and filtered. As much liquid as possible was removed by suction.

12. The crucible and residue were dried in a 105° C. oven for two hours.

13. The crucible was cooled in a desiccator and weighed to the nearest 0.0001 g.

14. Percent of hexane solubles was calculated using Equation 4.1.

$$\begin{matrix} Calculation & \\ \frac{( {W}_{2} - {W}_{1} )}{{W}_{s}} ⨯ 100 = \% Sulfuric acid insolubles & Eq . ( 4.1 )\end{matrix}$$

Where:

W₁=weight of the crucible and filter, g

W₂=weight of the crucible, filter, and dried residue, g

Wₛ=weight of the sample, g

The examples are merely set forth for illustrative purposes, but it is to be understood that other modifications of the present invention can be made by skilled artisans in the related industry without departing from the spirit and scope of the invention. The parts and percentages used in the examples being by weight unless otherwise indicated.

### EXAMPLES

Cutting of Loose RCL

Baled RCL was opened pulled apart by hand into loose fluff. The material was subsequently cut using a laboratory Netzsch-Condux model CS150/100-2 rotary cutter fitted with a 150 μm screen.

Decolorization of RCL by Caustic-Digestion of Cut RCL

### Example 1

To a resin kettle reactor equipped with a fritted funnel were charged cut RCL (100 g “as is” weight), 50% sodium hydroxide solution (117.2 g) and water (755.4 g). After sealing the reactor, the inside of the reactor was inerted by three cycles of evacuation and nitrogen purging. After that a nitrogen flow was maintained in the headspace. The resulting mixture was heated from 25° C. to 90° C. over a period of 75 minutes and held at 90° C. for 0.5 h to obtain black mother liquor containing suspended fibers.

The mother liquor was drained and the filtered cake cooled to 20° C. in 8 minutes by circulating ice water around the reactor jacket. The filtered cake was washed 12 times with water (800-900 g) at 22-24° C. till the filtrate was water clear. The purified RCL was dried in a fluid bed dryer at 50° C. for 20-30 minutes to obtain a fiber matrix.

The Hunter L whiteness of the RCL after caustic-digestion was 72.53.

### Example 2

The RCL/caustic slurry (caustic concentration=6.5%), described in Example 1, was heated from ambient temperature to 90° C. over a period of 75 minutes and held at 90° C. for 1 h.

Following this, the black liquor was drained off through the frit using gravity and 5 psi head pressure. The residue wet cake was washed 10-14 times using 800-900 g of hot water at 80° C. each time till the filtrate was color-free indicating complete extraction of the soluble colored species. At the last cycle of washing, the slurry was filtered under suction fitted with a rubber dam and the fibrous cake thus obtained was dried in a fluid bed dryer at 50° C. for 20-30 minutes to obtain a fiber matrix.

The Hunter L whiteness of the RCL after caustic-digestion was 79.60.

### Examples 3-8

Example 2 was repeated using the ingredients and conditions shown in Table 1. The Hunter L whiteness of the RCL after caustic treatment under different conditions is shown in Table 1.

TABLE 1
Hunter L Whiteness of Decolorized RCL made under Different Reaction Conditions

| | Reaction conditions to digest cut RCL with NaOH solution | | | | | |
|---|---|---|---|---|---|---|
| | Cut RCL | 50% NaOH | | NaOH Conc. | RCL slurry | Hunter L |
| Example | (g) | solution (g) | Water (g) | (wt %) | conc.(wt %) | whiteness |
| Control virgin RCL | | | | | | 69.48 |
| Control purified | | | | | | 93.54 |
| cotton linters | | | | | | |
| 3 | 100 | 87.41 | 771.80 | 5.1 | 9.9 | 74.70 |
| 4 | 150 | 170.45 | 1037.85 | 7.0 | 10.5 | 78.86 |
| 5 | 53.7 | 62.88 | 416.02 | 6.5 | 9.6 | 81.65 |
| 6 | 150 | 170.45 | 929.00 | 7.7 | 11.4 | 81.78 |
| 7 | 200 | 227.30 | 1320.70 | 7.3 | 10.9 | 81.95 |
| 8 | 150 | 170.50 | 775.50 | 8.9 | 13.0 | 82.24 |

Sulfuric Acid Insoluble Content of Decolorized RCL

The lignin content of various cellulose furnishes, as measured by digesting the cellulose furnishes with concentrated sulfuric acid, is shown in Table 2.

TABLE 2
Sulfuric acid insoluble content of RCL, decolorized RCL
and purified cotton linters

| | Sulfuric acid insoluble content |
|---|---|
| Cellulose furnish | (wt %) |
| Decolorized RCL | 0.94 |
| “As is” RCL | 6.42 |
| Purified cotton linters | 0.01 |

As can be seen, the sulfuric acid insoluble content (a measure of lignin content of the cellulose furnish) of the decolorized RCL was substantially lower than that of “as is” CL but not as low as that of purified cotton linters.

Effect of Digestion Temperature on the Whiteness of Decolorized RCL

According to Example 1, RCL/caustic slurry (caustic concentration=6.5%) was heated from 25° C. to 60, 70, or 90° C. over a period of 75 minutes and held at 60, 70, or 90° C. for 1 h.

The Hunter L whiteness values of the decolorized RCLs thus obtained under different conditions are shown in Table 3.

TABLE 3
Effect of Digestion Temperature
on the Whiteness of Caustic-Digested RCL

| | Digestion | |
|---|---|---|
| | Temperature | Hunter L |
| Example # | (° C.) | Whiteness |
| Control virgin RCL | | 69.48 |
| 9 | 60 | 64.68 |
| 10 | 70 | 76.18 |
| 7 | 90 | 81.95 |

As can be seen, the higher the digestion temperature, the higher the Hunter L whiteness value for the caustic-digested RCL.

Effect of Digestion Time on the Whiteness of Decolorized RCL

According to Example 1, RCL/caustic slurry (caustic concentration=6.5%) was heated from 25° C. to 90° C. over a period of 75 minutes and held at 90° C. for different lengths of time.

The Hunter L whiteness values of the decolorized RCLs thus obtained by digesting the RCL for different lengths of time are shown in Table 4.

TABLE 4
Effect of digestion time on the whiteness of caustic-digested RCL

| | Digestion Time | |
|---|---|---|
| Example # | @ 90° C. (hr) | Hunter L whiteness |
| Control virgin RCL | — | 69.48 |
| 11 | 0.0 | 65.23 |
| 1 | 0.5 | 72.53 |
| 7 | 1.0 | 81.95 |

As can be seen, the longer the digestion time the higher the Hunter L whiteness value of the caustic-digested RCL.

Carboxymethylation of Decolorized RCL

### Example 12

Carboxymethyl derivatives of decolorized RCLs were made by reacting base treated decolorized RCL with monochloroacetic acid according to the procedure described in Example 8 of U.S. patent Ser. No.10/822,926 (US Patent Application No. 2005/0228174 A1), incorporated herein by reference in its entirety.

The carboxymethylated derivatives thus formed were substantially less color than the carboxymethylated RCL (CM-RCL) made by carboxymethylating “as is” RCL (Example 13) under identical conditions. The results are shown in Table 5.

TABLE 5
Relative solution colors of 1% solutions of carboxymethylated derivatives
made from decolorized RCL, “as is” RCL and purified cotton linters

| | Cellulose furnish used to | Relative |
|---|---|---|
| Example | make the | solution |
| # | carboxymethylated derivative | color |
| 12 | Decolorized RCL | 17 |
| 13 | “As is” RCL | 85 |
| 14 | Purified cotton linters | 3 |

For comparison purposes, the relative solution color of carboxymethylated derivative made from purified cotton linters (Example 14) is also shown in Table 5.

Solution Viscosity of Carboxymethylated Derivative made from Caustic-Digested RCL

It was surprising to find that the carboxymethylated derivatives made from caustic-digested RCLs provided very high 1% solution viscosity. The results are shown in Table 6.

TABLE 6
1% Solution Brookfield viscosity of carboxymethylated
derivatives made from various cellulose furnishes

| | | | 1% Solution |
|---|---|---|---|
| | | | Brookfield |
| Example # | Cellulose Furnish used | DS^{a} | Viscosity^{b} (cP) |
| 13 | Decolorized RCL | 1.14 | 10,300 |
| 14 | ″ | 1.18 | 9,580 |
| 15 | “As is” RCL | 1.16 | 8,020 |
| 16 | Purified cotton linters | 1.15 | 5,720 |

^{a}DS is the degree of substitution of the carboxymethylated derivative and is defined as the average number of hydroxyls groups substituted with carboxymethyl groups per anhydroglucose unit of cellulose
^{b}Brookfield viscosity measured at 25° C. at 30 rpm using spindle #4

As can be seen, the carboxymethylated derivatives (Examples 13 and 14) made from decolorized RCL have higher solution viscosity compared to the carboxymethylated derivatives made from “as is” RCL (Example 15) and purified cotton linters (Example 16).

Hydroxyethylation of Decolorized RCL

### Examples 17-18

Hydroxyethyl derivatives of decolorized RCLs were made by reacting the base treated decolorized RCL with ethylene oxide according to the procedure described in Example 13 of U.S. patent Ser. No. 10/822,926 (US Patent Application No. 2005/0228174 A1). For comparison purposes, the corresponding hydroxyethylated derivatives were made from commercially available high molecular weight purified cotton linters (Southern 407; available from ADM-Southern Cotton Oil Company, Georgia). The results are shown in Table 7.

TABLE 7
1% solution Brookfield viscosity of hydroxyethylated derivatives
made from various cellulose furnishes

| | | | 1% Solution |
|---|---|---|---|
| | | | Brookfield |
| Example # | Cellulose furnish used | HE MS^{a} | Viscosity^{b} (cP) |
| 17 | Decolorized RCL | 2.7 | 6500 |
| 18 | ″ | 3.0 | 5000 |
| 19 | “As is” RCL | 2.9 | 5860 |
| 20 | ″ | 3.7 | 5240 |
| 21 | Purified cotton linters | 3.7 | 4000 |

^{a}HE MS is the degree of hydroxyethyl substitution of the hydroxyethylated derivative and is defined as the average number of moles of ethylene oxide grafted per anhydroglucose unit of cellulose
^{b}Brookfield viscosity measured at 25° C. at 30 rpm using spindle #4

As can be seen, the hydroxyethylated derivatives made from decolorized RCL had solution viscosity higher than the analogous hydroxyethylated derivative made from “as is” RCL and purified cotton linters.

Decolorization of Cut RCL at Elevated Temperatures and Pressures

### Examples 22-25

Caustic-digestion of cut RCL was conducted in a Metlab RC1 reaction calorimeter equipped with a hastalloy reaction chamber and stirrer. The bottom of the reactor was equipped with a bottom valve to allow rapid discharging of the reactor contents.

Cut RCL (100 g) and deionized water (840.24 g) were mixed to form uniform slurry and charged to the reactor. The reactor head was sealed and agitation was initiated. The reaction chamber was inerted by five vacuum purge cycles using nitrogen. The reactor was sealed and the slurry was heated to the target temperature. Sodium hydroxide (NaOH) beads were dissolved in water to for the targeted NaOH concentration and charged to the sealed vessel from a nitrogen pressurized stainless steel vessel. The reaction slurry was held at the desired temperature for 15 minutes with stirring. The reaction slurry was then discharge from the pressurized reactor by opening the bottom valve of the reactor into a stainless steel container containing 2 liters of deionized water. The resulting slurry was filtered using vacuum and a rubber dam. The resulting wet cake was washed with 2 liters of deionized water and filtered using vacuum and a rubber dam. The wet cake was washed with 2 liters of deionized water and the slurry was neutralized to pH 6.9-7.1 with 10% acetic acid. The slurry was vacuum filtered using a rubber dam and the resulting wet cake dried in a fluid bed drier for 20 minutes at 50° C.

TABLE 7
Hunter L whiteness of decolorized RCL made by digesting RCL with caustic
at elevated temperatures and pressures

| | | | | Reaction | Reactor | | | |
|---|---|---|---|---|---|---|---|---|
| | Caustic Charge | | Overall % | Temperature | Pressure | | % Mw | Hunter L |
| Example | Water (g) | NaOH (g) | NaOH | (° C.) | (psig) | Mw | Retained | Whiteness |
| Starting Cut | | | | | | 3,330,000 | | 64.2 |
| Raw Linters | | | | | | | | |
| 22 | 72.31 | 42.95 | 4.5 | 110 | 22 | 3,260,000 | 98% | 73.2 |
| 23 | 86.56 | 28.7 | 3 | 125 | 21 | 3,200,000 | 96% | 77.3 |
| 24 | 57.63 | 57.63 | 6 | 125 | 42 | 3,140,000 | 94% | 79.7 |
| 25 | 72.31 | 42.95 | 4.5 | 140 | 42 | 3,080,000 | 92% | 80.8 |

Examples 22-25 demonstrate high Hunter L whiteness values can be obtained with minimal degradation of cellulose molecular weight by extraction of cut RCL with caustic at elevated temperature and pressures.

While this invention has been described with respect to specific embodiments, it should be understood that these embodiments are not intended to be limiting and that many variations and modifications are possible without departing from the scope and spirit of this invention. Such variations and modifications are to be considered within the purview and scope of the claims appended hereto.

What is claimed:

1. A process for producing decolorized raw cotton linters (RCL) comprising
a) cutting a RCL mass so that at least 50% of cut RCL mass passes through a US Standard sieve size #10 (2 mm opening),
b) mixing cut RCL mass with from about 2% to about 10% of a base solution,
c) heating the cut RCL mass mixture at 90° C. to 180° C. for a sufficient time to digest color bodies contained in the RCL mass and producing a decolorized RCL,
d) an optional step of removing the base solution from the decolorized RCL,
e) washing the decolorized RCL with water to remove the base solution and color bodies from the decolorized raw cotton linters,
f) an optional step of treating the decolorized RCL mixture with an oxidizing agent,
g) an optional step of neutralizing and washing the decolorized RCL mixture and,
h) drying the decolorized RCL.

2. The process of claim 1, wherein at least 50% of the cut RCL mass passes through a US standard sieve size #18 (1 mm opening).

3. The process of claim 2, wherein at least 50% of the cut RCL mass passes through a US standard sieve #35 (0.5 mm opening).

4. The process of claim 3, wherein at least 50% of the cut RCL mass pass through a US standard sieve #60 (0.25 mm opening).

5. The process of claim 1 wherein the oxidizing agent of step (f) is selected from the group consisting of hydrogen peroxide, sodium hypochlorite, chlorine dioxide, chlorine, oxygen and ozone.

6. The process of claim 1 further comprising performing a mechanical cleaning step to remove a portion of bulk contaminants contained in the RCL mass prior to step (b).

7. The process of claim 6 wherein the mechanical cleaning step is performed either in a dry or slurry state.

8. The process of claim 1 wherein step c) is performed in a batch reactor.

9. The process of claim 1 wherein step c) is performed in a continuous reactor.

10. The process of claim 1 wherein step c) is performed in a substantially oxygen-free atmosphere.

11. The process of claim 1 wherein step d) utilizes a mechanical treatment to remove the excess fluid.

12. The process of claim 11 wherein the mechanical treatment is performed using equipment selected from the group consisting of centrifugation, screw press and belt press.

13. The process of claim 1 wherein the drying step h) is performed using equipment selected from the group consisting of tunnel belt dryers, impact dryers, tower dryers and multistage flash dyers.

14. The process of claim 1 wherein the decolorized RCL is substantially free of caustic.

15. The process of claim 1 wherein prior to step h) the decolorized RCL is neutralized with an acid.

16. The process of claim 1 wherein step e) is performed using a twin screw extruder equipped with multiple washing sections.

17. The process of claim 16 wherein effluent from the twin screw extruder equipped with multiple washing sections section is fed in a countercurrent manner.

18. The process of claim 1 wherein the decolorized RCL has a Hunter L whiteness of at least about 60.

19. The process of claim 18 wherein the decolorized RCL has a Hunter L whiteness at least about 70.

20. The process of claim 19 wherein the decolorized RCL has a Hunter L whiteness at least about 80.

21. The process of claim 1 wherein the base solution of step b) is selected from the group consisting of sodium hydroxide, potassium hydroxide, lithium hydroxide and mixtures thereof.

22. The process of claim 1 wherein the base solution of step b) further comprises a surfactant.

23. The process of claim 22 wherein the surfactant is selected from the group consisting of sulfonated castor oil, Turkey Red oil, FF wood rosin, crude tall oils and mixtures thereof.

24. A process for preparing a cellulose ether derivative from decolorized raw cotton linters (RCL) comprising the steps of;
a) cutting a RCL mass so that at least 50% of cut RCL mass passes through a US Standard sieve size #10 (2 mm opening),
b) mixing cut RCL mass with from about 2% to about 10% of a base solution,
c) heating the cut RCL mass mixture at 90° C. to 180° C. for a sufficient time to digest color bodies contained in the RCL mass and producing a decolorized RCL,
d) an optional step of removing the base solution from the decolorized RCL,
e) washing the decolorized RCL with water to remove the base solution and color bodies from the decolorized RCL,
f) an optional step of treating the decolorized RCL mixture with an oxidizing agent,
g) an optional step of neutralizing and washing the decolorized RCL mixture,
h) drying the decolorized RCL,
i) treating the decolorized RCL with a base, and
j) reacting the decolorized RCL with an etherifying agent or a mixture of etherifying agents at a sufficient temperature and for a sufficient time to form a final product containing an amount of a cellulose ether derivative.

25. The process of claim 24, wherein the decolorized RCL is first treated with the etherifying agent or the mixture of etherifying agents and then treated with the base to form the cellulose ether derivative.

26. The process of claim 24, wherein the decolorized RCL is treated simultaneously with the etherifying agent or the mixture of etherifying agents and the base to form the cellulose ether derivative.

27. The process of claim 24, wherein the base is selected from the group consisting of sodium hydroxide, potassium hydroxide, calcium hydroxide, barium hydroxide, ammonium hydroxide, lithium hydroxide, strong organic bases and mixtures thereof.

28. The process of claim 27 wherein the strong organic bases are selected from the group consisting of amines, quaternary ammonium hydroxides, and mixtures thereof.

29. The process of claim 24, wherein the etherifying agent is selected from the group consisting of alkyl halides, alkenyl halides, alkylene oxides, alkyl glycidyl ethers, aryl glycidyl ethers, alk(aryl) glycidyl ethers, metal salts of alpha-halogenoalkanoates, and vinyl sulfonates.

30. The process of claim 29 wherein the alkyl halides comprises an alkyl group having between 1 and 30 carbon atoms.

31. The process of claim 30 wherein the alkyl group has 1 carbon atom.

32. The process of claim 30 wherein the alkyl group has 4 carbon atoms.

33. The process of claim 30 wherein the alkyl group has 16 carbon atoms.

34. The process of claim 29 wherein the alkyl glycidyl ethers, aryl glycidyl ethers, alk(aryl) glycidyl ethers comprise an alkyl group containing between 1 and −30 carbon atoms.

35. The process of claim 24, wherein the etherifying agent is selected from the group consisting of methyl chloride, ethyl chloride, ethylene oxide, propylene oxide, monochloroacetic acid and salts thereof, butyl glycidyl ether, and glycidyl silane.

36. The process of claim 24, wherein the etherifying agent is either (3-glycidoxypropyl)trimethoxysilane, (3-glycidoxypropyl)methyldiethoxysilane or (3-glycidoxypropyl)dimethoxysilane.

37. The process of claim 24, wherein the etherifying agent is selected from the group consisting of vinyl sulfonate, 2-choloroethyl sulfonate, allyl halide, and allylglycidyl ether.

38. The process of claim 24, wherein the cellulose ether derivative is selected from the group consisting of carboxymethylcellulose (CMC), methylcellulose (MC), ethyl cellulose (EC), hydroxyethylcellulose (HEC), carboxymethylhydroxyethylcellulose (CMHEC), hydrophobically-modified hydroxyethylcellulose (HMHEC), hydrophobically modified carboxymethylhydroxyethylcellulose (HMCMHEC), methylhydroxyethylcellulose (MHEC), methylhydroxypropylcellulose (MHPC), ethylhydroxyethylcellulose (EHEC), hydrophobically-modified ethylhydroxyethylcellulose (HMEHEC), hydroxypropylcellulose (HPC), hydrophobically-modified hydroxypropylcellulose (HMHPC), allylated hydroxyethylcellulose, and sulfonated hydroxyethylcellulose.

39. The process of claim 24, wherein the cellulose ether derivative is cationically modified with a cationic reagent.

40. The process of claim 39 wherein the cellulose ether derivative is cationically modified using glycidyltrimethylammonium chloride as the cationic reagent.

41. The process of claim 39 wherein the cationic reagent comprises a hydrophobic group.

42. The process of claim 41, wherein the hydrophobic group present in the cationic reagent is an alkyl group containing from 2 to 20 carbon atoms.

43. The process of claim 24, wherein the cellulose ether derivative is further processed to increase its purity.

44. The process of claim 43, wherein the further processing comprises extracting nonpolymeric salts from the cellulose ether derivative with a liquid media in which the cellulose ether derivative is rendered substantially insoluble.

45. The process of claim 24, wherein the decolorized RCL or the cellulose ether derivative is further processed with a viscosity reducing agent to lower the intrinsic viscosity of the cellulose ether derivative.

46. The process of claim 45, wherein the viscosity reducing agent comprises a chemical means.

47. The process of claim 45, wherein the viscosity reducing agent comprises a mechanical means.

48. The process of claim 45, wherein the viscosity reducing agent comprises irradiation.

49. The process of claim 45, wherein the viscosity reducing agent comprises an enzymatic means.

50. The process of claim 24, wherein the final product contains at least about 65% by weight of the cellulose ether derivative.

51. The process of claim 50, wherein the final product contains at least about 75% of the cellulose ether derivative.

52. The process of claim 51, wherein the final product contains at least about 95% of the cellulose ether derivative.

53. The process of claim 24, wherein the decolorized RCL of step h) has a Hunter L whiteness of at least about 60.

54. The process of claim 53, wherein the decolorized RCL of step h) has a Hunter L whiteness at least about 70.

55. The process of claim 54 wherein the decolorized RCL of step h) has a Hunter L whiteness at least about 80.

56. The process of claim 55 wherein the decolorized RCL of step h) has a Hunter L whiteness at least about 95.
